(19) United States
(12) Patent Application Publication
(10) Pub. No.: US 2003/0136242 A1
(43) Pub. Date: Jul. 24, 2003

(54) Sawing tool for a manual circular sawing machine with coaxial saw blades that can be driven in opposite direction

(76) Inventors: Albrecht Hofmann, Steinbronn (DE); Ivo Gruber, Niklaus (CH); Thomas Schomisch, Englischgrussstrasse (CH)

Correspondence Address: Striker Striker & Stenby, 103 East Neck Road, Huntington, NY, 11743, US

(21) Appl. No.: 10/182,413

(22) PCT Filed: Sep. 29, 2001
(86) PCT No.: PCT/DE01/03751

(30) Foreign Application Priority Data
Dec. 2, 2000 (DE) 10059969.9

(51) Int. Cl. B23D 45/00

(52) U.S. Cl. 83/853; 30/369

(57) ABSTRACT

In the case of a sawing tool for a circular power saw having two coaxial saw blades (11, 11′) capable of being driven in opposite directions and rotating directly past each other, the anterior—relative to the direction of rotation—cutting edge (161, 161′) of each active cutting edge (16, 16′) is situated in a plane extending through the saw blade axis (18, 18′) to produce, using a simple design, an axial force on each saw blade (11, 11′) that counteracts the forcing apart of the saw blades (11, 11′) during the cutting process, and the active cutting edges (16, 16′) are sloped in the direction of the saw blade axes (18, 18′) in such a fashion that they incline downward from the facing sides of the saw blades (11, 11′) toward the sides of the blades facing away from each other (FIG. 5).

### BACKGROUND OF THE INVENTION

The invention is based on a sawing tool for a circular power saw having two coaxial saw blades capable of being driven in opposite directions and rotating directly past each other according to the general class defined in the preamble of claim 1.

Such sawing tools have the advantage that, when working with the manually-guided circular saw, the reaction forces and torques are eliminated by the opposing rotation of the two saw blades and the operator can guide the machine easily and with low reaction force. To obtain optimum cutting results, it is important that the two saw blades not be forced apart axially by the cutting forces acting in the cut. To prevent this, an axial force must be applied during the cutting process to the region of the tooth system engaging in the work piece, which said axial force counteracts the cutting force components that try to force the saw blades apart.

In the case of a known sawing tool of the type named initially (WO 89/00474), the active cutting edges of the sawteeth are arranged obliquely in relation to the plane of the saw blade to produce such an axial force counteracting the forcing apart of the saw blades, whereby the corner edges of the active cutting edges located further forward in the direction of rotation of the saw blades are suitated on the sides of the saw blades that directly face each other. Due to the cutting force of the active cutting edge, an axially directed force component therefore arises that holds the tooth system regions of the saw blades together axially in the cutting region.

### ADVANTAGES OF THE INVENTION

In each of its exemplary embodiments according to claims 1, 2, 3, 6 and 8, the sawing tool according to the invention has the basic advantage that, during operation, an axial force component is present that presses at least those tooth regions of the two saw blades together that are engaged in the work piece, and moreover has the further advantage that this force component is obtained using cost-effective production engineering measures so that the costs to produce the sawing tool can be lowered.

In the case of the exemplary embodiment according to claim 1, the active cutting edges situated with their anterior—relative to the direction of rotation—cutting edges in a plane extending through the coaxial saw blade axes, which said active cutting edges incline downward obliquely toward the outer sides of the saw blades, are much easier to produce than sloped active cutting edges, the anterior cutting edge of which has an acute angle having a plane extending through the saw blade axis, since the slope of the cutting edge need not be produced tooth by tooth. Instead, it can be ground in while the saw blade is rotating.

In the case of the examplary embodiment of the invention according to claim 2, the outer rounding of the two saw blades producing, again, an axial force component inwardly not only has the production-engineering advantage described hereinabove, it also offers greater protection against outer corner chipping that can be caused by vibrations in the case of manually-guided machines in particular.

In the case of the exemplary embodiment of the invention according to claim 3, the axial force component is not produced by the advance of the sawing tool. Rather, the tooth systems of the saw blades are pressed against each other by means of an elastic preload so that the saw blades bear against each other resiliently with low spring constants in the region of their tooth system. This spring force holds the saw blades together in the cut and counteracts the forcing apart of the saw blades during operation. Such an axial preload can be realized in various fashions, e.g., using the design features indicated in claim 4 or claim 5.

The exemplary embodiment of the invention according to claim 6 has the advantage that no modifications need be made to the saw blades to produce the axial force component to hold the saw blades together, so that conventional, inexpensive saw blades can be used. Due to the slightly oblique position of the saw blades and the saw blade axes that intersect in the symmetry plane of the sawing tool, a part of the tooth system on both of the saw blades is pressed together, which results in an inwardly directed axial force component that holds the saw blades together in the cut.

According to an advantageous further development of the exemplary embodiment according to claim 6, the facing-away-from-each-other, outer surfaces of the saw blade bodies of the two saw blades are set back slightly in relation to the facing-away-from-each-other, outer secondary cutting edges. As a result—despite a slightly oblique position of the saw blades—the sawing tool rubs not at all or only very slightly against the inner cut surfaces of the cut in the work piece.

In the case of the exemplary embodiment of the invention according to claim 8, the axial force component for holding the saw blades together during operation is obtained by situating the secondary cutting edges located on sides of the blades facing away from each other outwardly in relation to the saw blade bodies in such a fashion that the plane in which the secondary cutting edges are suitated forms the smallest possible helix angle with the saw blade body. As a result, the corner angle between the active cutting edge and the outer secondary cutting edge is as great as possible, but it is still less than 90°. This results in the blades being held together strongly, axially during operation than would be the case with a larger helix angle of the secondary cutting edges.

The hereinabove described exemplary embodiments of the sawing tool according to the invention are optimized further in terms of an improved cutting result when, according to a preferred exemplary embodiment of the invention, means are provided on each saw blade for forcing air to be conducted toward the teeth. This results in a very good cooling of the saw blades during operation and, therefore, in addition to an improved cutting result, to a long service life of the saw blades.

According to an advantageous further development, the air conduction means have through holes created in the saw blade bodies that are arranged preferably equidistantly on a subcircle concentric to the saw blade axis. An air turbulence that flows around the teeth is obtained by means of these through holes.

According to an advantageous further development, the air conduction means have blade-shaped spokes that are formed in the radial direction in the saw blade bodies. The spokes can have a cross section that increases outwardly constantly or continuously. The cross-sectional profile of the spokes can be angular, and the spokes are situated obliquely to the plane of the saw blade, or they are optimized for favorable aerodynamics and designed similar to aircraft wings.

According to another further development, the air conduction means in the saw blade body of one of the saw blades has pairs of radially separated through holes offset in relation to each other at preferably identical angles at circumference and, in the saw blade body of the other saw blade, oblong holes or grooves extending in the radial direction and offset in relation to each other at preferably identical angles at circumference, which said oblong holes or grooves overlap the pairs of bores when the two saw blades rotate. When grooves are provided instead of oblong holes, the amount of air moved per revolution of the saw blades is greater, since the air cannot escape to the side, as it can in the case of an oblong hole. The bores can be applied obliquely in the saw blade bodies so that the hole axes are tilted toward the saw blade plane. The end regions of the grooves or oblong holes are designed oblique in the same fashion. This further supports the conduction of air.

According to an alternative further development, the air conduction means in the saw blade body of the one saw blade have through holes arranged on a subcircle offset in relation to each other at preferably identical angles at circumference and, in the saw blade body of the other saw blade, radially extending oblong holes offset in relation to each other at identical angles at circumference, each of which said oblong holes open into a tooth gap on the circumference of the saw blade body and overlaps—by means of their end regions facing away from the opening—the through holes when the two saw blades rotate. The base of the tooth gap of the tooth system of the saw blade having the through holes is thereby preferably drawn more deeply inward than in the other saw blade. Identically arranged grooves can be provided in place of oblong holes.

A further optimization of the presented sawing tools in the direction of improving the cutting result is obtained when, according to an advantageous exemplary embodiment of the invention, the side faces located behind the active cutting edges in the direction of rotation in the tooth systems of the two saw blades are given a contour that inclines downward from the active cutting edge and inclines back upward toward the following tooth. The re-ascending contour reduces the maximum possible advance per tooth, by way of which vibrations are reduced. Although reducing the advance also reduces the maximum rate of advance, this is outweighed by the advantage of reduced vibration, given the limited output of manually-guided circular saws and the comparably yielding guidance of the machine by the operator.

### SUMMARY OF THE DRAWINGS

The drawings are described in greater detail in the subsequent description with reference to the exemplary embodiments presented in the drawings.

FIG. 1 shows a top view of a sawing tool having two circular saw blades rotating in opposite directions,

FIG. 2 shows a sectional drawing along the line II-II in FIG. 1,

FIG. 3 shows an enlarged view of section III in FIG. 1,

FIG. 4 shows a top view of the layout of the tooth system in direction IV in FIG. 3,

FIG. 5 shows a sectional drawing along the line V-V in FIG. 3,

FIG. 6 shows the same view as in FIG. 5 of a sawing tool according to a further exemplary embodiment,

FIG. 7 shows a side view of a sawing tool according to a third exemplary embodiment,

FIG. 8 shows a side view of a sawing tool according to a fourth exemplary embodiment,

FIG. 9 shows a side view of a sawing tool according to a fifth exemplary embodiment,

FIG. 10 shows an enlarged view of section X in FIG. 9,

FIG. 11 shows the same view as in FIGS. 5 and 6 of a sawing tool according to a sixth exemplary embodiment,

FIGS. 12 through 14 show a top view of the saw blade body of a saw blade of the sawing tool in FIGS. 1 through 6 according to three exemplary embodiments,

FIG. 15 shows a sectional drawing along the line XV-XV in FIG. 13,

FIG. 16 shows the same illustration as in FIG. 15 according to a further exemplary embodiment,

FIG. 17 shows a longitudinal view of the saw blade bodies of a sawing tool according to FIGS. 1 through 6 with the sectional direction along line XVII-XVII in FIG. 19 in two variants,

FIG. 18 shows a top view in the direction of arrow XVIII in FIG. 17,

FIG. 19 shows a top view in the direction of arrow IXX in FIG. 17,

FIG. 20 shows sections of a top view of a sawing tool according to a further exemplary embodiment,

FIG. 21 shows sections of a saw blade of a sawing tool according to a further exemplary embodiment.

### DESCRIPTION OF THE PREFERRED EMBODIMENTS

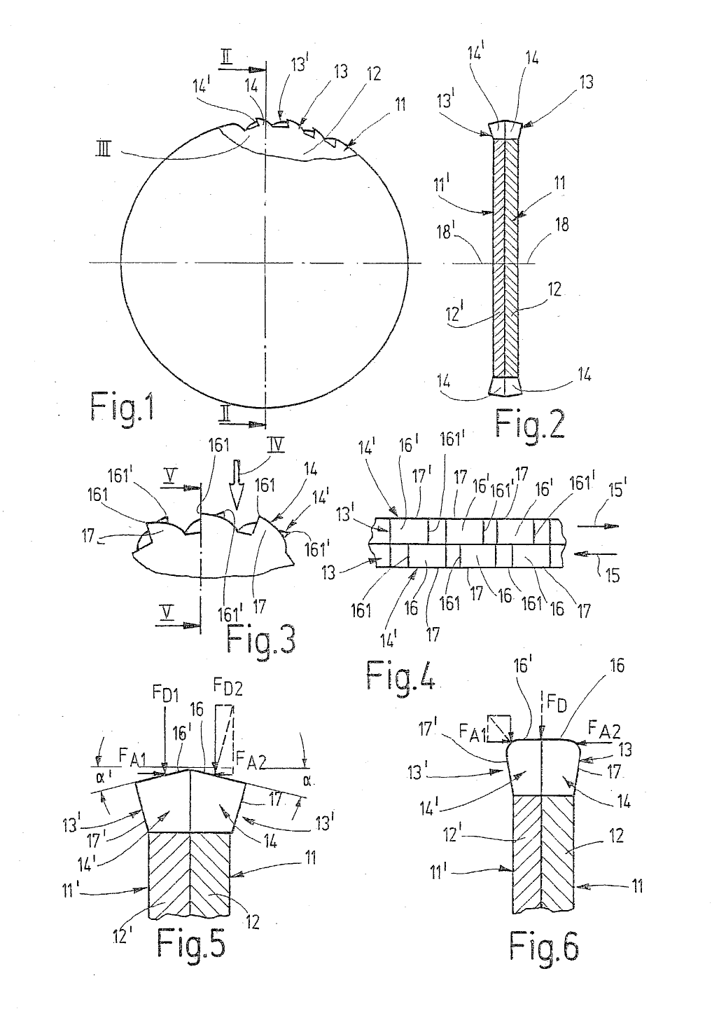

The sawing tool for a circular power saw shown in FIGS. 1 through 5 in various views and sectional drawings has two coaxial circular saw blades capable of being driven in opposite directions and rotating directly past each other, referred to hereinbelow as saw blades 11, 12. After being clamped into the tool receptacle of a circular power saw not shown here, each one of said circular saw blades is connected in torsion-resistant fashion with one of two concentrically arranged drive spindles rotating in opposite directions. Each saw blade 11 and 11′ has a saw blade body 12 and 12′ and a tooth system 13 and 13′ composed of a plurality of teeth 14 and 14′ arranged equidistantly in tandem and protruding individually radially out of the saw blade body 12, 12′. Only four teeth 14, 14′ of the encircling tooth system 13, 13′ are shown in FIG. 1, and the rest of the saw blade 11 is represented by a circle running along the tips of the teeth. Each tooth 14 and 14′ has an active cutting edge 16 and 16′ pointing in the direction of rotation 15 and 15′ (FIG. 4) and two radially extending secondary cutting edges 17 and 17′ laterally abutting the active cutting edge. Active cutting edges 16 and 16′ and secondary cutting edges 17 and 17′ meet at the corners. The outer secondary cutting edges 17 and 17′ facing away from each other in the case of abutting saw blades 11, 11′ are adjusted lightly against the respective saw blade body 12 or 12′ so that the outer corners formed by active cutting edges 16, 16′ and outer secondary cutting edges 17, 17′ protrude axially over the outer surface of the respective saw blade body 12 or 12′. As illustrated in FIG. 4 and FIG. 5, each anterior—relative to the direction of rotation—cutting edge 161 and 161′ of the active cutting edges 16, 16′ is situated in a plane extending through the saw blade axis 18 and 18′, whereby, at the same time, the active cutting edges 17, 17′ are sloped in the direction of the saw blade axis 18 or 18′ in such a fashion that the active cutting edges 17, 17′ incline downward from the facing sides of the saw blades 11, 11′ toward the sides of the blades facing away from each other. The helix angle of the active cutting edges 17 and 17′ is labelled α and α′ in FIG. 5 and it is equal for both saw blades 11, 11′. Due to these helix angles α and α′, an axial force F_{A1} and F_{A2} that is equal to ½ Fp·tan α is produced by means of a compressive force Fₚ caused by the force applied by the operator and half of which acts each on the active cutting edges 16 and 16′ with the compressive force Fₚ₁ and Fₚ₂. As the pressure Fₚ that the operator applies on the machine and the sawing tool in the cut increases, this axial force holds the two saw blades 11, 11′ together axially with increasing force.

In the case of the modified exemplary embodiment of the sawing tool according to FIG. 6, this axial force F_{A1} and F_{A2}—which counteracts the forcing apart of the two saw blades 11, 11′ in the cutting region—is obtained by means of a rounding of the transition from the active cutting edge 16 or 16′ toward the outer secondary cutting edge 17 or 17′ in the case of abutting saw blades 11, 11′. The rounding of the cutting edge transition also provides greater protection against outer corner chipping that can be caused by vibrations in the case of manually-guided machines in particular.

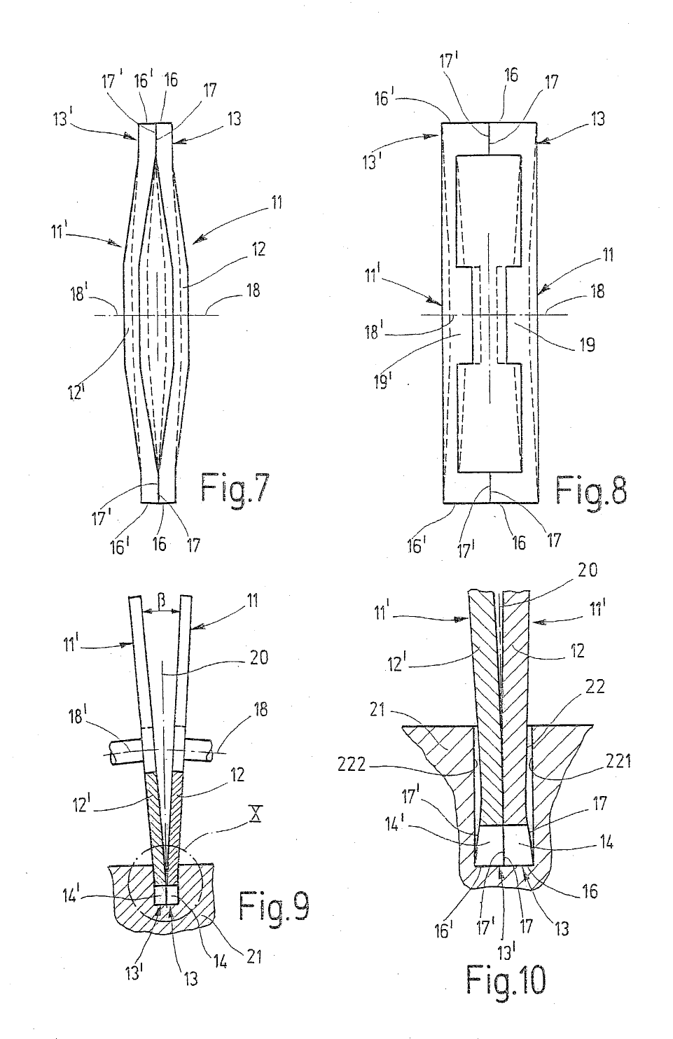

In the case of the exemplary embodiments of the sawing tool according FIGS. 7 and 8, the axial force for holding the saw blades 11, 11′ together during operation is obtained by means of an axial preloading of the saw blades 11, 11′. In this case, the two saw blades 11, 11′ bear against each other axially resiliently with low spring constants in the region of their tooth system 13, 13′. In the exemplary embodiment according to FIG. 7, the elastic preload in the axial direction is obtained by the fact that the saw blade bodies 12, 12′ of the two saw blades 11, 11′ have the beginnings of a conical shape that tapers toward the sides of the blades facing away from each other, which said shape is obtained by means of a forging procedure following the production process. In FIG. 7, the solid lines represent the saw blades 11, 11′ in their strain-free position, and the dotted lines represent said saw blades in their clamped position in the tool receptacle of the circular power saw in which they obtain the elastic preload.

In FIG. 8, in order to obtain the elastic preload, the saw blade bodies 12, 12′ of the two saw blades 11, 11′ are reduced from the facing sides of the blades outward, and a mounting hub 19 and 19′ protrudes from each saw blade body 12 or 12′ in the direction toward the other saw blade body 12′ or 12. The height of the mounting hubs 19, 19′ is dimensioned so that, on the end side, it recedes behind the plane of the abutting inner secondary cutting edges 17, 17′. The saw blades 11, 11′ bearing against each other without preload are represented in FIG. 8 using solid lines. When the sawing tool is clamped in the tool receptacle of the circular power saw, the two saw blades 11, 11′ assume the position represented in FIG. 8 with dashed lines. As a result, the tooth systems 13, 13′ of the two saw blades 11, 11′ are pressed against each other axially.

In the case of the exemplary embodiment of the sawing tool according to FIG. 9, the axial force—which prevents the saw blades 11, 11′ from being forced apart during operation—is produced by the oblique positioning of the saw blades 11, 11′. The two saw blades 11, 11′ are thereby positioned in relation to each other at a small acute angle β in such a fashion that the saw blade axes 18, 18′ intersect in the symmetry plane 20 of the sawing tool. As a result, the teeth 14, 14′ are pressed against each other axially in the region of their secondary cutting edges 17, 17′ within a subregion of the tooth systems 13, 13′ of the two saw blades 11, 11′. An enlarged view of the secondary cutting edges 17, 17′ bearing against each other during engagement in a work piece 21 is shown in FIG. 10. It is clearly visible that the outer surfaces of the saw blade bodies 12, 12′ facing away from each other are set back slightly in relation to the outer secondary cutting edges 17, 17′ facing away from each other, so that, along the depth of the cut, there is no or only very little rubbing against the inner surfaces 221, 222 of the cut 22 in the work piece 21.

In the exemplary embodiment of the sawing tool according to FIG. 11, the axial force F_{A1} or F_{A2} is obtained by means of large corner angles between the active cutting edge 16 and 16′ and the outer secondary cutting edge 17 and 17′. This corner angle is selected as great as possible, but it is always less than 90°. The secondary cutting edges 17 and 17′ situated on sides of the blade facing away from each other are therefore situated in relation to the saw blade body 12 and 12′ in such a fashion that the plane in which the outer secondary cutting edges 17 and 17′ are situated forms the smallest possible helix angle γ or γ′ with the associated saw blade body 12 and 12′. The helix angles γ and γ′ at the two saw blades 11, 11′ are selected equal in size. In comparison, the oblique position of the outer secondary cutting edge 17 that is common with conventional saw blades is represented in FIG. 11 using dashed lines. The helix angle γ* is markedly greater than the helix angle γ of the novel saw blade 11.

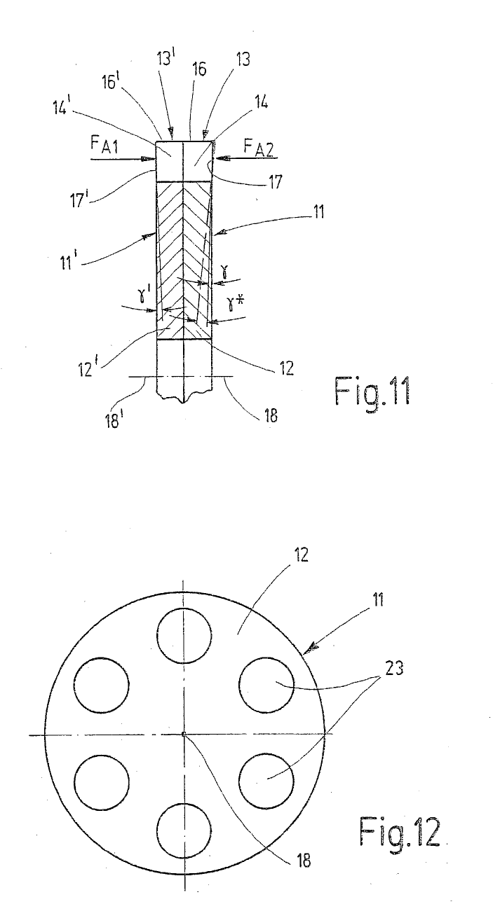

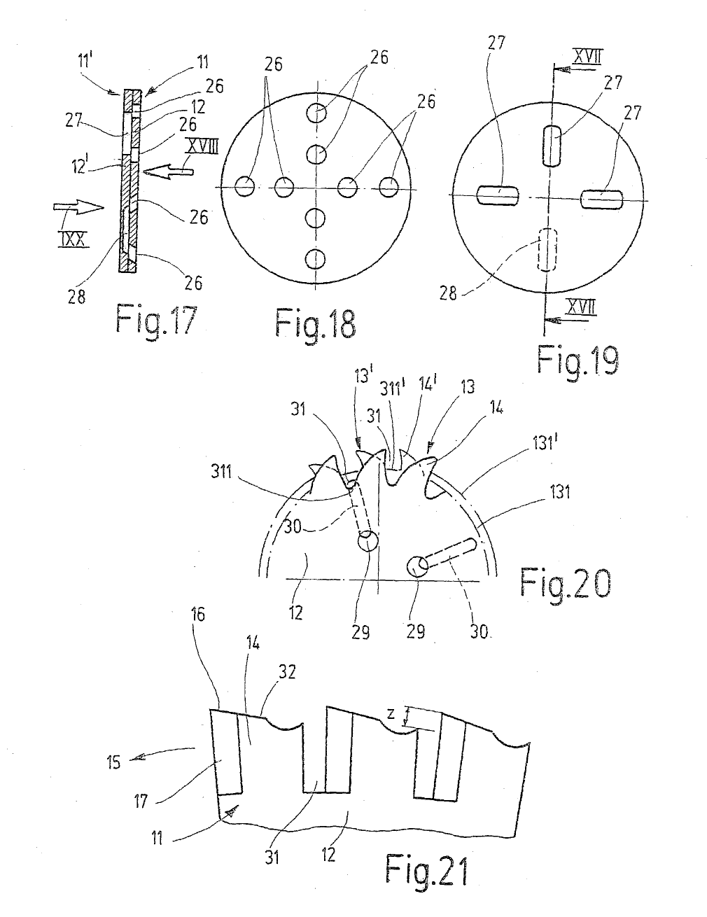

Means for forcing air to be conducted toward the tooth system 13 and 13′ are provided on each saw blade 11 and 11′ in every sawing tool described. These air conduction means are realized differently according to the exemplary embodiments in FIGS. 12 through 20. In every case, however, when saw blades 11, 11′ are rotating in opposite directions, air is conducted from the inside radially toward the outside to the tooth systems 13, 13′ of the saw blades 11, 11′, thereby cooling the tooth region and effectively dissipating heat away from the saw blades 11, 11′. The air conduction means are formed in the saw blade bodies 12, 12′ of the two saw blades so that only the saw blade bodies 12 and 12′ are shown in the exemplary embodiments of FIGS. 12 through 19 of the saw blades 11, 11′.

In the case of the exemplary embodiment according to FIG. 12, through holes 23 are applied in the saw blade body 12, which said through holes are preferably arranged on a subcircle concentric to the saw blade axis 18. The not shown saw blade body 12′ of the saw blade 11′ has identical bores. As a result of the through holes 23 and 23′ rotating past each other, air turbulence is created during the sawing operation that brings about a cooling effect on the tooth systems 13, 13′ and the saw blade bodies 12, 12′.

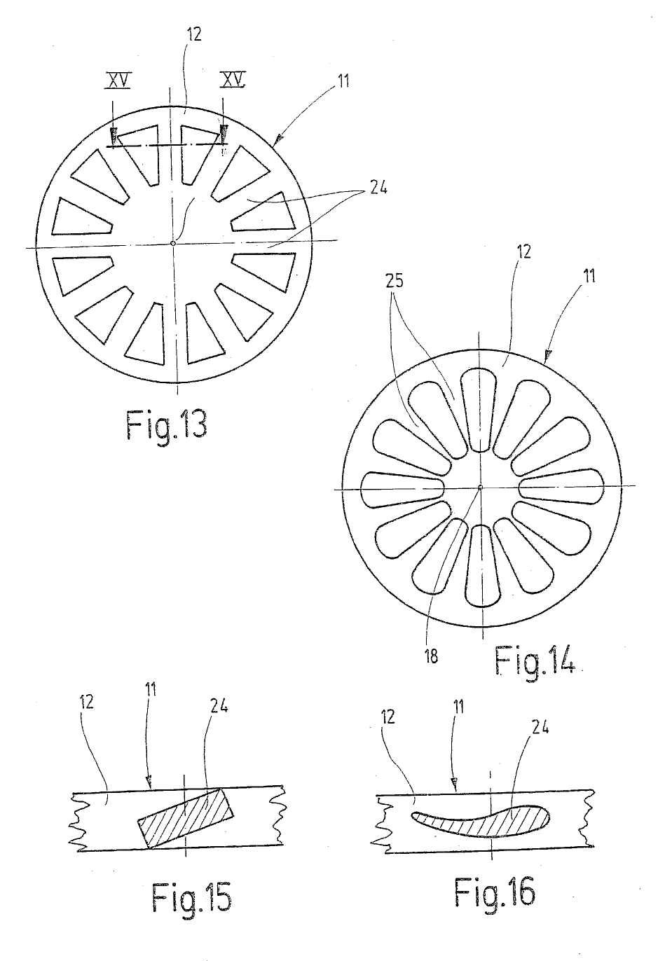

In the case of the exemplary embodiments according to FIGS. 13 and 14, spokes 24 and 25 are formed in the saw blade body 12 of the saw blade 11, which said spokes extend in the radial direction and, in the exemplary embodiment according to FIG. 13, have a cross section that is constant along their length, while, in the exemplary embodiment according to FIG. 14, they have a cross section that increases continuously toward the outside. As shown in the sectional drawing in FIG. 15, the spokes 24 have a rectangular profile and are positioned in relation to the plane of the saw blade in such a fashion that, during rotation, they direct the air inwardly in the fashion of vanes. In a modification of the spokes 24 as shown in FIG. 16, the spokes 24 have an aerodynamically optimized profile similar to the profile of an aircraft wing. In this case as well, the saw blade body 12′ of the other saw blade 11′—which is not shown in FIGS. 13 through 16—is identical in design.

In the case of the two exemplary embodiments of a supply of cooling air to the tooth systems 13, 13′ of the saw blades 11, 11′ shown in FIGS. 17 through 19, the air conduction means arranged in the saw blade bodies 12, 12′, on the one hand, are realized by means of pairs of radially separated through holes 26 offset in relation to each other at identical angles at circumference in the one saw blade body 12 and, on the other hand, by means of oblong holes 27 extending in the radial direction separated from each other at identical angles at circumference in the saw blade body 12′ of the other saw blade 11′, which said oblong holes overlap the pairs of through holes 26 with their end regions when the two saw blades 11, 11′ rotate. A modification is shown in the lower section of FIGS. 17 through 19. In this case, the oblong holes are replaced by grooves 28 placed in the same location, as shown in a sectional drawing in FIG. 17 and using dashed lines in a concealed top view in FIG. 19. When the two saw blades 11, 11′ rotate in opposing directions, air suction is produced from the inside toward the outside that cools the tooth systems 13, 13′. When grooves 28 are provided instead of oblong holes 27, the amount of air moved per revolution is greater, since the air is unable to escape to the side, as is the case with the oblong hole 27. In a further modification—as indicated in the bottom section of FIGS. 17 through 19 as well—the through holes 26 are designed with axes that extend obliquely toward the plane of the blade, and the grooves 28 are sloped downward in the end section. This supports the supply of air to the tooth systems 13,13′ as well. A downward sloping of the ends of the oblong holes 27 has the same effect.

In the case of the exemplary embodiment of the sawing tool presented in FIG. 20, in which the tooth systems 13, 13′ are designed as described previously, air conduction means are also provided in the saw blade bodies 12, 12′ to supply air to the tooth systems 13, 13′. For this purpose, through holes 29 are arranged—offset in relation to each other at identical angles at circumference—in the saw blade body 12 of the one saw blade 11 on a subcircle, and radially extending oblong holes 30—offset at identical angles at circumference—are arranged in the saw blade body 12′ of the other saw blade 11′. In each case, the oblong holes 30 open, on the circumference of the saw blade body, into a tooth gap 31 and are dimensioned so long that they overlap the through holes 29 with their end regions opposite to the opening when the two saw blades 11, 11′ rotate. As shown in FIG. 20, the base of the tooth gap 311 of the saw blade 11 having the through holes 29 is drawn radially lower than the base of the tooth gap 311′ in the tooth system 13 of the other saw blade 11′. Grooves having an identical design can be provided in place of the oblong holes 30. In FIG. 20, only three teeth 14 and 14′ of the tooth systems 13, 13′ are shown, and the remainder of the tooth system 13, 13′ is indicated by the subcircles 131, 131′.

To reduce vibrations during manual sawing, all tooth systems 13, 13′ are advantageously designed as shown using sections of a saw blade 11 in FIG. 21. The side faces 32 situated behind the active cutting edges 16 in the direction of rotation are given a contour that inclines downward starting at the active cutting edge 16 and inclines back upward toward the subsequent tooth 14. As a result of this ascension, the maximum possible advance per tooth 14 decreases, which is indicated in FIG. 21 by the dimension z. Although this decrease also reduces the maximum rate of advance, this is outweighed by the advantage of reduced vibrations, given the limited output of circular power saws and the comparably yielding guidance by the operator.

What is claimed is:

1. A sawing tool for a circular power saw having two coaxial saw blades (11, 11′) capable of being driven in opposite directions and rotating directly past each other, each of which said saw blade has a saw blade body (12, 12′) and a tooth system (13, 13′) encircling the saw blade body (12, 12′) composed of a plurality of teeth (14, 14′) arranged equidistantly in tandem and protruding individually radially out of the saw blade body (12, 12′), each of which said tooth system has an active cutting edge (16, 16′) pointing in the direction of rotation and two radially extending secondary cutting edges (17, 17′) laterally abutting the active cutting edge,
wherein, on each saw blade (11, 11′), the anterior—relative to the direction of rotation—cutting edge (161, 161′) of each active cutting edge (16, 16′) is situated in a plane extending through the saw blade axis (18, 18′), and the active cutting edges (16, 16′) are sloped in the direction of the saw blade axes (18, 18′) in such a fashion that the active cutting edges (16, 16′) incline downward from the facing sides of the saw blades (11, 11′) toward the sides of the blades facing away from each other.

2. The sawing tool according to the preamble of claim 1,
wherein, on each saw blade (11, 11′), the active cutting edges (16, 16′) extend parallel to the saw blade axis (18, 18′) and the transitions from the active cutting edges (16, 16′) are rounded at least to the outer secondary cutting edges (17, 17′) situated on sides of the blades facing away from each other.

3. The sawing tool according to the preamble of claim 1,
wherein the saw blades (11, 11′) bear against each other axially resiliently with low spring constants in the region of their tooth systems (13, 13′).

4. The sawing tool according to claim 3,
wherein the saw blade bodies (12, 12′) of the two saw blades (11, 11′) have a conical shape tapering toward the sides of the blades facing away from each other that is obtained preferably by means of a forging process following the saw blade production process.

5. The sawing tool according to claim 3,
wherein, in the two saw blades (11, 11′), the axial strength of the saw blade bodies (12, 12′) is reduced from the facing sides of the blades outward, and a coaxial mounting hub (19, 19′) protrudes from each of the saw blade bodies (12, 12′) on facing blade surfaces, the exposed end of which recedes axially behind the facing inner secondary cutting edges (17, 17′) of the teeth (14, 14′).

6. The sawing tool according to the preamble of claim 1,
wherein the two saw blades (11, 11′) having saw blade axes (18, 18′) intersecting in the symmetry plane (20) of the sawing tool are adjusted in relation to each other at a small acute angle (β) in such a fashion that, within a subregion of their tooth system (13, 13′), the teeth (14, 14′) of the two saw blades (11, 11′) bear against each other axially.

7. The sawing tool according to claim 6,
wherein facing-away-from-each-other, outer blade surfaces of the saw blade bodies (12, 12′) of the two saw blades (11, 11′) are set back slightly in relation to the facing-away-from-each-other, outer secondary cutting edges (17, 17′).

8. The sawing tool according to the preamble of claim 1,
wherein at least the outer secondary cutting edges (17, 17′) situated on the sides of the blades facing away from each other are positioned in relation to the saw blade bodies (12, 12′) in such a fashion that the plane in which the outer secondary cutting edges (17, 17′) are situated forms the smallest possible helix angle (γ, γ′) with the saw blade body (12, 12′).

9. The sawing tool according to one of the claims 1 through 8,
wherein means are provided on each saw blade (11, 11′) for forcing air to be conducted toward the teeth (13, 13′).

10. The sawing tool according to one of the claims 1 through 9,
wherein, in the tooth systems (13, 13′) of the two saw blades (11, 11′), side faces (32) situated behind the active cutting edges (16, 16′) in the direction of rotation have a contour that inclines downward starting from the active cutting edge (16, 16′) and inclines back upward toward the subsequent tooth (14, 14′).
